(19) United States
(12) Patent Application Publication
(10) Pub. No.: US 2019/0346708 A1
(43) Pub. Date: Nov. 14, 2019

(54) VIEWING ANGLE SWITCHING DEVICE AND DISPLAY APPARATUS

(71) Applicants: Beijing BOE Optoelectronics Technology Co., Ltd., Beijing (CN); BOE Technology Group Co., Ltd., Beijing (CN)

(72) Inventors: Xuerong WANG, Beijing (CN); Haiwei SUN, Beijing (CN); Dong CHEN, Beijing (CN); Lei CHEN, Beijing (CN); Lu YU, Beijing (CN); Fei GAO, Beijing (CN)

(21) Appl. No.: 16/080,552

(22) PCT Filed: Dec. 14, 2017
(86) PCT No.: PCT/CN2017/116151

§ 371 Date: Aug. 28, 2018

(30) Foreign Application Priority Data
Jan. 16, 2017 (CN) 201710029257.3

(51) Int. Cl. G02F 1/13; G02F 1/1334; G02F 1/137; G02F 1/1343; G02F 1/1333; G02F 1/133

(52) U.S. Cl. CPC G02F 1/1323; G02F 1/1334; G02F 1/13306; G02F 1/13439; G02F 1/133305; G02F 1/13781

(57) ABSTRACT

A viewing angle switching device for a display apparatus is disclosed. The viewing angle switching device includes an optical adjustment layer for switching between a transmissive state and a scattering state. The optical adjustment layer is configured to direct light incident on the optical adjustment layer to exit in the original incident direction in the transmissive state, and to scatter light incident on the optical adjustment layer in the scattering state. A display apparatus is further disclosed. When the viewing angle switching device is applied to a display apparatus, switching between a wide viewing angle and a narrow viewing angle can be realized in the same display apparatus.

### CROSS REFERENCE TO RELATED APPLICATIONS

The present application claims the benefit of Chinese Patent Application No. 201710029257.3, filed on Jan. 16, 2017, the entire disclosure of which is incorporated herein by reference.

### TECHNICAL FIELD

The present disclosure relates to the field of display technologies, and particularly to a viewing angle switching device and a display apparatus.

### BACKGROUND

In the field of display technologies, people have different viewing angle requirements when displaying information on a liquid crystal display apparatus in different scenarios. For example, in some scenarios where information anti-peep is required, people use a display apparatus with a narrow viewing angle for private display; when a wide viewing angle is required, people use a display apparatus with a wide viewing angle to meet the needs of multi-person multi-angle co-viewing. However, in the prior art, switching between a wide viewing angle and a narrow viewing angle cannot be realized in the same display apparatus, and the user's demands for diverse display of the display apparatus cannot be satisfied.

### SUMMARY

The present disclosure provides a viewing angle switching device for a display apparatus, comprising an optical adjustment layer capable of switching between a transmissive state and a scattering state, the optical adjustment layer is configured to enable light incident on the optical adjustment layer to exit in the original incident direction in the transmissive state, and to scatter light incident on the optical adjustment layer in the scattering state.

In an embodiment, the optical adjustment layer is a polymer dispersed liquid crystal layer, and a transparent electrode layers is disposed on each side of the optical adjustment layer.

In an embodiment, the polymer dispersed liquid crystal layer comprises a polymer matrix and smectic liquid crystals mixed in the polymer matrix.

In an embodiment, a transparent insulating layer is disposed on a side of eachtransparent electrode layer away from the optical adjustment layer.

In an embodiment, the transparent insulating layer is made from a material comprising polybutylene terephthalate.

Accordingly, the present disclosure further provides a display apparatus comprising a display device, the display device comprises a light emitting component configured to emit light for display. The display apparatus further comprises the above-described viewing angle switching device according to the present disclosure. The viewing angle switching device is disposed on a light exit side of the light emitting component.

In an embodiment, the display device further comprises a liquid crystal display panel. The light emitting component is a backlight that provides light to the liquid crystal display panel, and the viewing angle switching device is disposed between the backlight and the liquid crystal display panel.

In an embodiment, the display apparatus further comprises an anti-peep layer between the liquid crystal display panel and the backlight. The anti-peep layer comprises a plurality of light blocking walls, and regions of the anti-peep layer between every two adjacent light blocking walls form light transmitting regions. The viewing angle switching device is disposed between the anti-peep layer and the liquid crystal display panel.

In an embodiment, the optical adjustment layer is a polymer dispersed liquid crystal layer, and a transparent electrode layer is disposed on each side of the optical adjustment layer. The display apparatus further comprises a driving device, and the driving device comprises a first output terminal and a second output terminal which are connected to the respective transparent electrode layer. The driving device is configured to output a driving voltage between the first output terminal and the second output terminal. The driving voltage drives the polymer dispersed liquid crystal layer into the transmissive state. A controllable switch is further disposed between the driving device and the transparent electrode layer.

In an embodiment, the driving device comprises a voltage output circuit, a power supply terminal, a low level signal terminal, and a gating circuit. A first output terminal of the voltage output circuit is connected to one of two transparent electrode layers. A second output terminal of the voltage output circuit is connected to a control terminal of the gating circuit. The first terminal of the gating circuit is connected to the power supply terminal and the first terminal of the controllable switch. The second terminal of the controllable switch is connected to the other one of the two transparent electrode layers. The second terminal of the gating circuit is connected to the low level signal terminal. The voltage output circuit is configured to alternately provide a validating signal to enable conduction between the first terminal and the second terminal of the gating circuit and an invalidating signal to disable conduction between the first terminal and the second terminal of the gating circuit. The power supply terminal is configured to provide a high level voltage that drives the polymer dispersed liquid crystal layer into the transmissive state.

In an embodiment, the display apparatus further comprises a first resistor between the control terminal of the gating circuit and the voltage output circuit, and a second resistor between the first terminal of the gating circuit and the power supply terminal.

In an embodiment, the gating circuit comprises a thin film transistor. A gate electrode of the thin film transistor is a control terminal of the gating circuit. A first pole of the thin film transistor is the first terminal of the gating circuit. A second pole of the thin film transistor is the second terminal of the gating circuit.

In an embodiment, the voltage output circuit alternately provides the validating signal and the invalidating signal at a frequency of 50 Hz˜70 Hz.

### BRIEF DESCRIPTION OF THE DRAWINGS

The drawings are used to provide a further understanding of the disclosure, and constituted as a part of the specification. The drawings are used to explain this disclosure together with the following detailed description, but not to limit the scope of the disclosure. In the drawings:

FIG. 1 is a schematic diagram of a viewing angle switching device comprising a protective layer in an embodiment of the present disclosure;

FIG. 2 is a schematic diagram for illustrating a viewing angle switching device in a transmissive state in an embodiment of the present disclosure;

FIG. 3 is a schematic diagram for illustrating a viewing angle switching device in a scattering state in an embodiment of the present disclosure;

FIG. 4 is a structural diagram for illustrating a display apparatus in an embodiment of the present disclosure;

FIG. 5 is a schematic diagram for illustrating connection between a driving device and transparent electrode layers in an embodiment of the present disclosure;

FIG. 6 is a waveform diagram for illustrating an output voltage of a driving device and an output voltage waveform of a voltage output circuit;

FIG. 7 is a curve for illustrating a relationship between brightness and a viewing angle of a display apparatus in which a viewing angle switching device is comprised and an anti-peep layer is not comprised in an embodiment of the present disclosure; and

FIG. 8 is a curve for illustrating a relationship between brightness and a viewing angle of a display apparatus shown in FIG. 4.

### DETAILED DESCRIPTION OF EMBODIMENTS

The specific embodiments of the present disclosure will be described in detail below with reference to the accompanying drawings. It shall be understood that the specific embodiments described herein are only used to illustrate and explain the disclosure, but not to limit the disclosure.

Reference numerals: 10 viewing angle switching device; 11 optical adjustment layer; 111 liquid crystal droplets; 12 transparent electrode layer; 13 transparent insulating layer; 14 protective layer; 20 liquid crystal display apparatus; 30 backlight; 31 back plate; 32 light guide plate; 33 light-emitting member; 34 optical film; 35 reflective sheet; 40 anti-peep layer; 41 light blocking wall; 42 transparent film; 50 driving device; o_1 first output terminal of driving device; o_2 second output terminal of driving device; 51 voltage output circuit; 52 gating circuit; VDD power supply terminal; VSS low level signal terminal; 60 controllable switch.

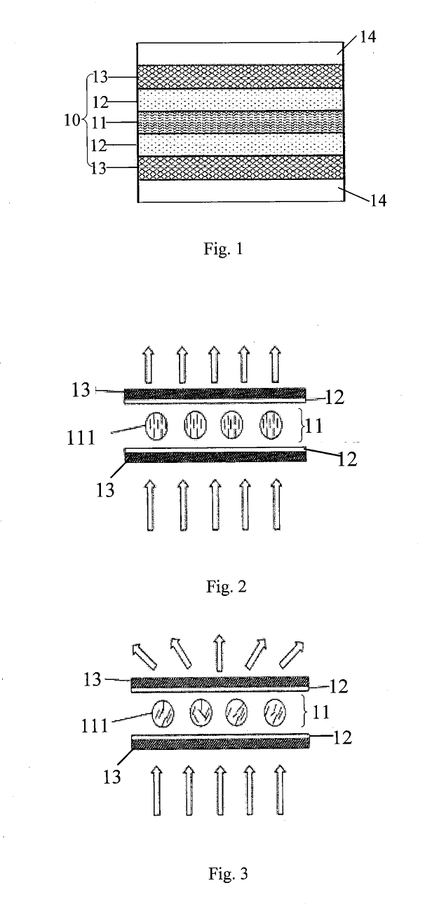

In an aspect of the present disclosure, it is provided a viewing angle switching device 10 for a display apparatus. As shown in FIG. 1 to FIG. 3, the viewing angle switching device 10 comprises an optical adjustment layer 11 capable of switching between a transmissive state and a scattering state. The optical adjustment layer 11 is configured to enable light incident on the optical adjustment layer to exit in the original incident direction in the transmissive state, and to scatter light incident on the optical adjustment layer in the scattering state.

The viewing angle switching device 10 can be disposed between the backlight and the display panel in the liquid crystal display apparatus, on a light exit side of the display panel, or on a light exit side of the OLED display apparatus. When the optical adjustment layer 11 is in the transmissive state, the direction of light is not changed. In this case, the viewing angle of the display apparatus is the same as or similar to the viewing angle of the display apparatus in which the viewing angle switching device 10 is not comprised. When the optical adjustment layer 11 is in the scattering state, the light is scattered. In this case, the light emitted from the display apparatus can be further diffused to increase the viewing angle. Therefore, when the viewing angle switching device 10 is applied to a display apparatus, switching between a wide viewing angle and a narrow viewing angle can be realized in the same display apparatus, thereby satisfying the requirements in different scenarios.

Specifically, the optical adjustment layer 11 is a polymer dispersed liquid crystal layer. As shown in FIG. 1, a transparent electrode layer 12 is disposed on each side of the optical adjustment layer 11. The polymer dispersed liquid crystal layer comprises a polymer matrix and smectic liquid crystals mixed in the polymer matrix. The smectic liquid crystal has better stability than the nematic liquid crystal. Specifically, the materials of the polymer matrix can comprise one or more components selected from the group consisting of hydroxypropyl acrylate, hydroxypropyl methacrylate, lauryl acrylate, lauryl methacrylate, isobornyl acrylate, isobornyl methacrylate, Hexanediol diacrylate, ethyl phenoxy acrylate, ethyl phenoxy methacrylate, trimethylcyclohexyl acrylate, benzyl methacrylate, hexyl acrylate, hexyl methacrylate, polyethylene glycol diacrylate, and ethoxylated bisphenol A dimethacrylate.

During fabrication, the smectic liquid crystals and the above-described material for preparing the polymer matrix can be uniformly mixed, and then extruded between the two transparent electrode layers 12 to form a film, which is then irradiated with ultraviolet light at a temperature of 25° C. A polymer dispersed liquid crystal layer between the two transparent electrode layers is obtained. In the resulting polymer dispersed liquid crystal layer, the liquid crystals are present in the polymer matrix in the form of micron-sized droplets. When different electrical signals are respectively applied to the two transparent electrode layers 12 to generate an electric field therebetween, as shown in FIG. 2, the molecules in the liquid crystal droplets 111 are regularly arranged along the direction of the electric field, so that the optical adjustment layer 11 is in the transmissive state. When the electric field between the two transparent electrode layers 12 is absent, due to the anchoring effect between the liquid crystal molecules and the substrate interface, the liquid crystal molecules is disorderly distributed, as shown in FIG. 3. In this case, the optical adjustment layer 11 is in the scattering state. The smectic liquid crystal has better stability and can maintain a stable transmissive state and scattering state.

Technical parameters of the viewing angle switching device 10 are shown in Table 1. When the viewing angle switching device is energized, a square wave with voltages switched between 0/5 V is applied between the two transparent electrode layers 12. Of course, a sine wave can also be applied.

TABLE 1

| Item | | Test method | Unit | Mode | Paramater | | Remark |
|---|---|---|---|---|---|---|---|
| Optical | Transmittance | ASTM | % | Power on | 90 ± 1% | | Test |
| paramaters | | D1003 | | | | | equipment: |
| | | ASTM | | Power off | 69 ± 1% | | WGT-S |
| | | D1003 | | | | | transmittance/ |
| | Haze | ASTM | | Power on | <3% | | haze tester |
| | | D1003 | | | | | |
| | | ASTM | | Power off | 67 ± 1% | | |
| | | D1003 | | | | | |
| | Color | ASTM | | ΔX | 0.0058 | 0.0035 | |
| | coordinate | D2244 | | | (Power | (Power | |
| | deviation | | | | off) | on) | |
| | | ASTM | | ΔY | 0.0033 | 0.0099 | |
| | | D2244 | | | (Power | (Power | |
| | | | | | off) | on) | |

| | | | | | |
|---|---|---|---|---|---|
| Electrical | Operating | | V | Power on | 0/5 V square wave |
| paramaters | voltage | | | | |
| | | | V | Power off | 0 V |
| Mechanical | Thickness | ISO4593 | μm | — | 120 ± 5 μm |
| paramaters | | | | | |
| Environmental | Operating | ISO9211 | ° C. | — | −20~80° C. |
| paramaters | temperature | | | | |
| | Storage | ISO9211 | ° C. | — | −20~80° C. |
| | temperature | | | | |

In order to protect the electrode layer, as shown in FIG. 1, a transparent insulating layer 13 is disposed on a side of each transparent electrode layer 12 away from the optical adjustment layer 11, so as to protect the transparent electrode layer 12. The material of the transparent insulating layer 13 comprises polybutylene terephthalate (PET).

In practical production, a protective layer 14 can be disposed on a side of each transparent insulating layer 13 away from the transparent electrode layer 12, to prevent the transparent insulating layer 13 from being damaged. When the viewing angle switching device 10 is disposed in the display apparatus, the protective layer 14 is peeled off. The material of the protective layer 14 can also comprise polybutylene terephthalate (PET).

In another aspect of the present disclosure, it is provided a display apparatus comprising a display device and the viewing angle switching device 10 as described above. The display device comprises a light emitting component configured to emit light to display, and the viewing angle switching device 10 is disposed on a light exit side of the light emitting component.

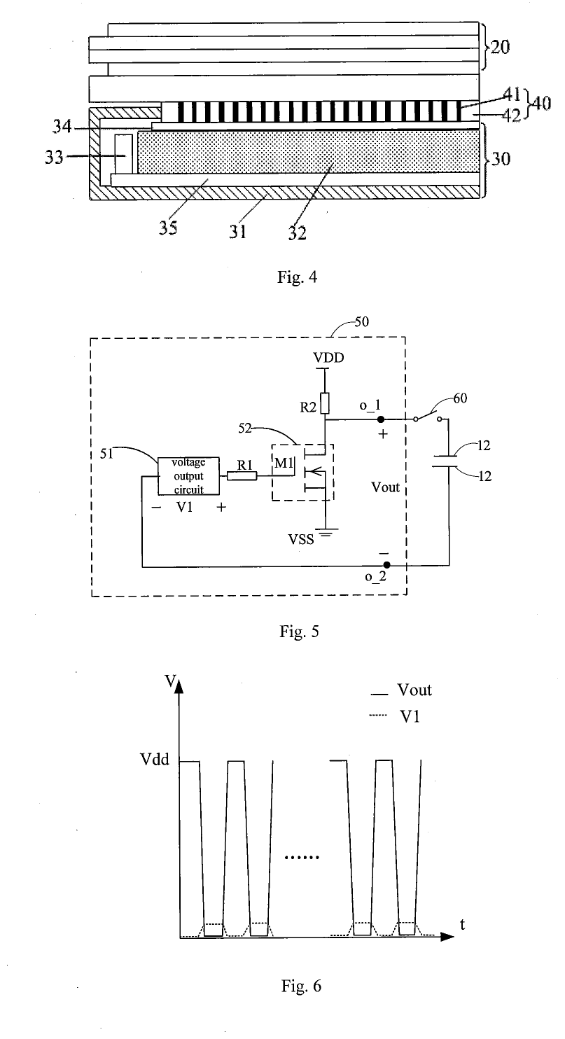

The display apparatus in an embodiment of the present disclosure can specifically be a liquid crystal display apparatus. That is, as shown in FIG. 4, the display device further comprises a liquid crystal display panel 20. In this case, the light emitting component is a backlight 30 that provides light to the liquid crystal display panel 20. As shown in FIG. 4, the backlight 30 specifically comprises a back plate 31, a light guide plate 32 in the back plate, a light-emitting member 33 on a light entrance side of the light guide plate 32, an optical film 34 on a light exit side of the light guide plate 32, and a reflective sheet 35 between a bottom surface of the light guide plate 32 and the back plate 31. The viewing angle switching device 10 is disposed on the light exit side of the backlight 30. That is, the viewing angle switching device can be disposed between the backlight 30 and the liquid crystal display panel 20, or on a light exit side of the liquid crystal display panel 20. In order to prevent a certain haze from affecting the display effect when the optical adjustment layer 11 is in the scattering state, the viewing angle switching device 10 is disposed between the backlight 30 and the liquid crystal display panel 20 in an embodiment of the present disclosure.

Of course, the display apparatus can also be an organic light emitting Diode (OLED) display apparatus. In this case, the light emitting component is an organic electroluminescent device, and the viewing angle switching device 10 is disposed on the light exit side of the organic light emitting device.

In case the display apparatus is a liquid crystal display apparatus, for example, as shown in FIG. 4, the display apparatus further comprises an anti-peep layer 40 disposed between the liquid crystal display panel 20 and the backlight 30. The anti-peep layer 40 comprises a plurality of light blocking walls 41, and regions of the anti-peep layer 40 between every two adjacent light blocking walls form light transmitting regions. A side of the light blocking wall 41 facing the corresponding light transmitting region is a light blocking surface. The viewing angle switching device 10 is disposed between the anti-peep layer 40 and the liquid crystal display panel 20. The anti-peep layer 40 can further comprise a transparent film 42. The light blocking walls 41 are disposed in the transparent film 42. The side of the light blocking wall 41 facing the corresponding light transmitting region can be a reflective surface or a light absorbing surface, as long as light can be prevented from passing through the light blocking wall 41.

As shown in FIG. 4, when the incident angle of the light from the backlight 30 to the anti-peep layer 40 (i.e. the angle between the incident direction and a thickness direction of the anti-peep layer 40) is greater than a certain value, the light can't exit from the anti-peep layer 40 under the light blocking effect of the light blocking walls 41. When the incident angle is smaller than the certain value, the light can exit from the anti-peep layer 40, thereby limiting the light exit angle of the backlight 30 (i.e. the angle between the light exit direction and the thickness direction of the backlight 30) to a certain range. Therefore, when the viewing angle switching device 10 is in the transmissive state, the direction of the light passing through the viewing angle switching device 10 does not change, and the light is still incident into the liquid crystal display panel 20 at a small incident angle, thereby making the light exit angle of the liquid crystal display panel 20 small and realizing the narrow viewing angle display, i.e. the anti-peep display. When the viewing angle switching device 10 is in the scattering state, the light is scattered after passing through the viewing angle switching device 10, so that the incident angle that incident into the liquid crystal display panel 20 is increased, thereby making the incident angle that incident into the liquid crystal display panel 20 increase and realizing the wide viewing angle display. Under the cooperation of the viewing angle switching device 10 and the anti-peep layer 40, the switching between the wide viewing angle and the narrow viewing angle of the display apparatus is more pronounced.

In the anti-peep layer 40, the plurality of light blocking walls 41 can be sequentially and in parallel arranged in the same direction, thereby enabling the display apparatus to realize the anti-peep display in the direction in which the light blocking walls 41 are arranged. Also the plurality of light blocking walls 41 can be disposed along a length direction and a width direction of the display apparatus respectively, so that the display apparatus can realize anti-peep effect in both the length direction and the width direction, thereby improving the anti-peep of display.

As described above, the optical adjustment layer 11 is specifically a polymer dispersed liquid crystal layer, and the transparent electrode layers 12 are disposed on both sides of the optical adjustment layer 11. In this case, the display apparatus further comprises a driving device 50, as shown in FIG. 5. The driving device 50 comprises a first output terminal o_1 and a second output terminal o_2, and the first output terminal o_1 and the second output terminal o_2 of the driving device are respectively connected to the two transparent electrode layers 12. The driving device 50 is configured to output a driving voltage Vout between the first output terminal o_1 and the second output terminal o_2, and the driving voltage Vout is configured to drive the polymer dispersed liquid crystal layer into a transmissive state. A controllable switch 60 is further disposed between the driving device 50 and the transparent electrode layer 12. Therefore, when the controllable switch 60 is switched on, the first output terminal o_1 and the second output terminal o_2 of the driving device 50 are respectively electrically connected to the two transparent electrode layers 12, so that voltage between the two transparent electrode layers 12 reach the driving voltage Vout, thereby driving the polymer dispersed liquid crystal layer to be aligned along the direction of the electric field and the viewing angle switching device 10 enter the transmissive state.

Specifically, as shown in FIG. 5, the driving device 50 comprises a voltage output circuit 51, a power supply terminal VDD, a low level signal terminal VSS, and a gating circuit 52. A first output terminal of the voltage output circuit 51 is connected to one of the two transparent electrode layers 12, and a second output terminal of the voltage output circuit 51 is connected to the control terminal of the gating circuit 52. The first terminal of the gating circuit 52 is connected to the power supply terminal VDD and the first terminal of the controllable switch 60, and the second terminal of the controllable switch 60 is connected to the other one of the two transparent electrode layers 12. The second terminal of the gating circuit 52 is connected to the low level signal end VSS. The voltage output circuit 51 is configured to alternately provide a validating signal to enable conduction between the first terminal and the second terminal of the gating circuit 52 and an invalidating signal to disable conduction between the first terminal and the second terminal of the gating circuit 52. The power supply terminal VDD is configured to provide a high level voltage Vdd which drives the polymer dispersed liquid crystal layer into the transmissive state. A first resistor R1 is further disposed between the control terminal of the gating circuit 52 and the voltage output circuit 51. A second resistor R2 is further disposed between the first terminal of the gating circuit 52 and the power supply terminal VDD.

The frequency at which the voltage output circuit 51 alternately provides the validating signal and the invalidating signal is between 50 Hz and 70 Hz. The gating circuit 52 comprises a thin film transistor M1. A gate electrode of the thin film transistor M1 is the control terminal of the gating circuit 52. A first pole of the thin film transistor M1 is the first terminal of the gating circuit 52, and a second pole of the thin film transistor M1 is the second terminal of the gating circuit 52. That is, the gate electrode of the thin film transistor M1 is connected to the second output terminal of the voltage output circuit 51, the first pole of the thin film transistor M1 is connected to the power supply terminal VDD and the first terminal of the controllable switch 60, and the second pole of the thin film transistor M1 is connected to the low level signal terminal VSS. The thin film transistor M1 can specifically be an N-type thin film transistor. Accordingly, the validating signal is a high level voltage signal, and the invalidating signal is a low level voltage signal. The low level signal terminal VSS can specifically be a ground terminal.

In case a wide viewing angle display is required, the controllable switch 60 is switched off to disconnect the two transparent electrode layers 12 from the driving device 50, thereby causing the liquid crystal in the polymer dispersed liquid crystal layer to be randomly oriented. As a result, the light incident into the polymer dispersed liquid crystal layer is scattered to exhibit a scattering state. In case a narrow viewing angle display is required, the controllable switch 60 is switched on, and the voltage V1 between the first output terminal and the second output terminal of the voltage output circuit 51 is alternately switched between the low level voltage and the high level voltage. When V1 is a low level voltage, the thin film transistor is switched off, and the voltage between the two transparent electrode layers 12 (i.e. the driving voltage Vout output by the driving device 50) reaches the voltage Vdd of the power supply terminal VDD. When V1 is a high level voltage, the thin film transistor M1 is switched on, and the voltage Vout between the two transparent electrode layers 12 is zero. As shown in FIG. 6, the voltage between the two transparent electrode layers 12 is a square wave whose frequency is the same as V1 and whose amplitude is switched between 0 and Vdd. Optically, an inverter circuit can be disposed between the driving device 50 and the transparent electrode layer 12 of the viewing angle switching device 10, such that the voltage between the two transparent electrode layers 12 is formed as a square wave of ±Vdd.

It should be understood that although the voltage V1 output by the voltage output circuit 51 is switched between a high level and a low level, the polymer dispersed liquid crystal layer remains in a scattering state for the human eye due to the large switching frequency. The switching of the voltage V1 output by the voltage output circuit 51 can prevent the liquid crystal of the polymer dispersed liquid crystal layer from being polarized.

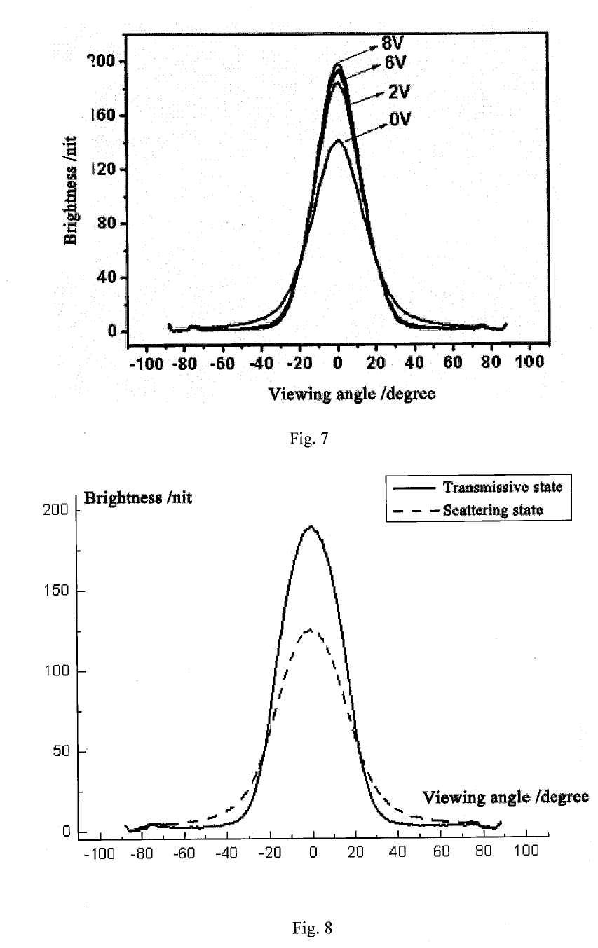

In case the display apparatus is a liquid crystal display apparatus, and the viewing angle switching device 10 is disposed between the liquid crystal display panel 20 and the backlight 30, when the two transparent electrode layers 12 of the viewing angle switching device 10 reach different voltages, the relationship between the brightness and the viewing angle of the display apparatus is shown in FIG. 7. It can be seen that when the optical adjustment layer 11 is in a transmissive state (i.e. the voltage between the two transparent electrode layers 12 is zero), the viewing angle range of the display apparatus is small. When the optical adjustment layer 11 is in a scattering state (i.e. the voltage between the two transparent electrode layers 10 is not zero), the viewing angle range of the display apparatus is large. The central brightness of the display apparatus increases with the increasing voltage between the two transparent electrode layers 12 of the viewing angle switching device 10. When the voltage increases to 2 V˜6 V, the central brightness of the display apparatus increases slowly with the increasing voltage. Therefore, in order to prevent the power consumption of the display apparatus from being excessively high with increasing the brightness of the display apparatus, the voltage Vdd of the above power supply terminal is set to be 5 V.

Table 2 is a table for illustrating comparison between parameters of the display apparatus in which the viewing angle switching device 10 and the anti-peep layer 40 are comprised and the parameters of the original state. Here, the viewing angle switching device 10 is disposed between the liquid crystal display panel 20 and the backlight 30, and the anti-peep layer 40 is disposed between the viewing angle switching device 10 and the backlight. 10% central brightness angle in Table 2 refers to a viewing angle range in which the viewing brightness can reach 10% of the central brightness, and the original state refers to a state in which the display apparatus is not provided with the viewing angle switching device 10 and the anti-peep layer 40.

TABLE 2
Optical paramaters

| | 10% | 5% | 2% | |
|---|---|---|---|---|
| | centeral | centeral | centeral | |
| | brightness | brightness | brightness | |
| Item | angle | angle | angle | Color difference |
| Original | ±58° | ±82° | ±88° | — |
| state | | | | |
| Transmissive | ±29° | ±32° | ±42° | Transmissive state → |
| state | | | | scattering state |
| | | | | Δx: 0.023 |
| | | | | Δy: 0.066 |
| Scattering | ±43° | ±55° | ±82° | |
| state | | | | |

Mechanical paramaters

| | | | Border |
|---|---|---|---|
| Item | Thickness | Weight | left/right/top/bottom |
| Original state | 2.31 mm | No more than | 3.25/3.25/3.25/8.91 |
| | | 215 g | |
| Transmissive | 2.75 mm | No more than | 3.25/3.25/3.25/8.91 |
| state | | 230 g | |
| Scattering state | 2.75 mm | No more than | 3.25/3.25/3.25/8.91 |
| | | 230 g | |

It can be seen from Table 2 that, in case the viewing angle switching device 10 and the anti-peep layer 40 are simultaneously provided, when the viewing angle switching device 10 is in the transmissive state, the viewing angle of the display apparatus is significantly reduced with respect to the original state; when the viewing angle switching device 10 is in the scattering state, the viewing angle of the display apparatus is significantly increased with respect to the transmissive state. Thus, the viewing angle switching effect of the display apparatus is more pronounced.

FIG. 8 is a relationship curve between brightness and viewing angle of the display apparatus shown in FIG. 4 in the transmissive state and in the scattering state. As can also be seen from FIG. 8, when the optical adjustment layer 11 of the viewing angle switching device 10 is in the transmissive state, the viewing angle of the display apparatus is between −40° and 40°. When the optical adjustment layer 11 of the viewing angle switching device 10 is in the scattering state, the viewing angle of the display apparatus is between −80° and 80°. The viewing angle switching effect is more pronounced.

The foregoing is a description of the viewing angle switching device and the display apparatus according to the present disclosure. It can be seen that the viewing angle switching device according to embodiments of the present disclosure can cause the display apparatus to switch between a narrow viewing angle and a wide viewing angle when used in a display apparatus. Also, when the display apparatus is provided with an anti-peep layer, the switching effect is more pronounced, so that the display requirements in different scenarios can be satisfied.

It is to be understood that, the above embodiments are merely exemplary embodiments employed to explain the principles of the present disclosure. However, the present disclosure is not limited thereto. Various modifications and improvements can be made by those skilled in the art without departing from the spirit and scope of the disclosure, and such modifications and improvements are also considered to be within the scope of the disclosure.

1. A viewing angle switching device for a display apparatus, comprising:
an optical adjustment layer configured to switch between a transmissive state and a scattering state, and configured to direct light incident on the optical adjustment layer to exit in an original incident direction in the transmissive state, and to scatter light incident on the optical adjustment layer in the scattering state.

2. The viewing angle switching device according to claim 1,
wherein the optical adjustment layer comprises a polymer dispersed liquid crystal layer, and
wherein a first transparent electrode layer is on a first side of the optical adjustment layer, and
wherein a second transparent electrode layer is on a second side of the optical adjustment layer that is opposite the first transparent electrode layer.

3. The viewing angle switching device according to claim 2,
wherein the polymer dispersed liquid crystal layer comprises a polymer matrix and smectic liquid crystals mixed in the polymer matrix.

4. The viewing angle switching device according to claim 2,
wherein a first transparent insulating layer is on the first transparent electrode layer opposite the optical adjustment layer, and
wherein a second transparent insulating layer is on the second transparent electrode layer opposite the optical adjustment layer.

5. The viewing angle switching device according to claim 4,
wherein the transparent insulating layer comprises a material comprising polybutylene terephthalate.

6. A display apparatus comprising:
a display device,
wherein the display device comprises a light emitting component configured to emit light for display,
wherein the display apparatus further comprises a viewing angle switching device which is on a light exit side of the light emitting component,
wherein the viewing angle switching device comprises an optical adjustment layer that is configured to switch between a transmissive state and a scattering state, and
wherein the optical adjustment layer is configured to direct light incident on the optical adjustment layer to exit in an original incident direction in the transmissive state, and to scatter light incident on the optical adjustment layer in the scattering state.

7. The display apparatus of claim 6, wherein the display device further comprises:
a liquid crystal display panel,
wherein the light emitting component comprises a backlight that is configured to provide light to the liquid crystal display panel, and
wherein the viewing angle switching device is between the backlight and the liquid crystal display panel.

8. The display apparatus of claim 7, further comprising:
an anti-peep layer between the liquid crystal display panel and the backlight,
wherein the anti-peep layer comprises a plurality of light blocking walls,
wherein regions of the anti-peep layer between two adjacent light blocking walls form light transmitting regions, and
wherein the viewing angle switching device is between the anti-peep layer and the liquid crystal display panel.

9. The display apparatus according to claim 6,
wherein the optical adjustment layer comprises a polymer dispersed liquid crystal layer,
wherein a first transparent electrode layer is on a first side of the optical adjustment layer,
wherein a second transparent electrode layer is on a second side of the optical adjustment layer that is opposite the first transparent electrode layer,
wherein the display apparatus further comprises a driving device,
wherein the driving device comprises a first output terminal of the driving device and a second output terminal of the driving device which are respectively connected to the the first transparent electrode layer and the second transparent electrode layer,
wherein the driving device is configured to output a driving voltage between the first output terminal of the driving device and the second output terminal of the driving device,
wherein the driving voltage switches the polymer dispersed liquid crystal layer into the transmissive state, and
wherein a controllable switch is between the driving device and the first transparent electrode layer.

10. The display apparatus according to claim 9, wherein the driving device comprises:
a voltage output circuit,
a power supply terminal,
a low level signal terminal, and
a gating circuit,
wherein a first output terminal of the voltage output circuit is connected to one of the first transparent electrode layer or the second transparent electrode layer,
wherein a second output terminal of the voltage output circuit is connected to a control terminal of the gating circuit,
wherein a first terminal of the gating circuit is connected to the power supply terminal and a first terminal of the controllable switch,
wherein a second terminal of the controllable switch is connected to another one of the first transparent electrode layer or the second transparent electrode layer,
wherein a second terminal of the gating circuit is connected to the low level signal terminal,
wherein the voltage output circuit is configured to alternately provide a validating signal to provide conduction between the first terminal of the gating circuit and the second terminal of the gating circuit, and an invalidating signal to disable conduction between the first terminal of the gating circuit and the second terminal of the gating circuit, and
wherein the power supply terminal is configured to provide a high level voltage that switches the polymer dispersed liquid crystal layer into the transmissive state.

11. The display apparatus according to claim 10, further comprising:
a first resistor between the control terminal of the gating circuit and the voltage output circuit, and
a second resistor between the first terminal of the gating circuit and the power supply terminal.

12. The display apparatus according to claim 10,
wherein the gating circuit comprises a thin film transistor,
wherein a gate electrode of the thin film transistor comprises the control terminal of the gating circuit,
wherein a first pole of the thin film transistor comprises the first terminal of the gating circuit, and
wherein a second pole of the thin film transistor comprises the second terminal of the gating circuit.

13. The display apparatus according to claim 10,
wherein the voltage output circuit is configured to alternately provide the validating signal and the invalidating signal at a frequency between 50 Hz to 70 Hz.

14. The display apparatus according to claim 7,
wherein the optical adjustment layer comprises a polymer dispersed liquid crystal layer,
wherein a first transparent electrode layer is on a first side of the optical adjustment layer,
wherein a second transparent electrode layer is on a second side of the optical adjustment layer that is opposite the first transparent electrode layer,
wherein the display apparatus further comprises a driving device,
wherein the driving device comprises a first output terminal connected to the first transparent electrode layer and a second output terminal connected to the second transparent electrode layer,
wherein the driving device is configured to output a driving voltage between the first output terminal and the second output terminal,
wherein the driving voltage switches the polymer dispersed liquid crystal layer into the transmissive state, and
wherein a controllable switch is between the driving device and one of the first transparent electrode layer or the second transparent electrode layer.

15. The display apparatus according to claim 8, wherein the driving device comprises:
a voltage output circuit,
a power supply terminal,
a low level signal terminal, and
a gating circuit,
wherein a first output terminal of the voltage output circuit is connected to one of the first transparent electrode layer or the second transparent electrode layer,
wherein a second output terminal of the voltage output circuit is connected to a control terminal of the gating circuit,
wherein a first terminal of the gating circuit is connected to the power supply terminal and a first terminal of the controllable switch,
wherein a second terminal of the controllable switch is connected to another one of the first transparent electrode layer or the second transparent electrode layer, and
wherein a second terminal of the gating circuit is connected to the low level signal terminal;
wherein the voltage output circuit is configured to alternately provide a validating signal to provide conduction between the first terminal of the gating circuit and the second terminal of the gating circuit, and an invalidating signal to disable conduction between the first terminal of the gating circuit and the second terminal of the gating circuit, and
wherein the power supply terminal is configured to provide a high level voltage that switches the polymer dispersed liquid crystal layer into the transmissive state.

16. The display apparatus according to claim 8,
wherein the optical adjustment layer comprises a polymer dispersed liquid crystal layer,
wherein a first transparent electrode layer is on a first side of the optical adjustment layer,
wherein a second transparent electrode layer is on a second side of the optical adjustment layer that is opposite the first transparent electrode layer,
wherein the display apparatus further comprises a driving device,
wherein the driving device comprises a first output terminal of the driving device and a second output terminal of the driving device which are respectively connected to the first transparent electrode layer and the second transparent electrode layer,
wherein the driving device is configured to output a driving voltage between the first output terminal of the driving device and the second output terminal of the driving device,
wherein the driving voltage switches the polymer dispersed liquid crystal layer into the transmissive state, and
wherein a controllable switch is between the driving device and the first transparent electrode layer.

17. The display apparatus according to claim 16, wherein the driving device comprises:
a voltage output circuit,
a power supply terminal,
a low level signal terminal, and
a gating circuit,
wherein a first output terminal of the voltage output circuit is connected to one of the first transparent electrode layer or the second transparent electrode layer,
wherein a second output terminal of the voltage output circuit is connected to a control terminal of the gating circuit,
wherein a first terminal of the gating circuit is connected to the power supply terminal and a first terminal of the controllable switch,
wherein a second terminal of the controllable switch is connected to another one of the first transparent electrode layer or the second transparent electrode layer, and
wherein a second terminal of the gating circuit is connected to the low level signal terminal;
wherein the voltage output circuit is configured to alternately provide a validating signal to provide conduction between the first terminal of the gating circuit and the second terminal of the gating circuit, and an invalidating signal to disable conduction between the first terminal of the gating circuit and the second terminal of the gating circuit, and
wherein the power supply terminal is configured to provide a high level voltage that switches the polymer dispersed liquid crystal layer into the transmissive state.

18. The display apparatus according to claim 17, further comprising:
a first resistor between the control terminal of the gating circuit and the voltage output circuit, and
a second resistor between the first terminal of the gating circuit and the power supply terminal.

19. The display apparatus according to claim 17,
wherein the gating circuit comprises a thin film transistor,
wherein a gate electrode of the thin film transistor comprises the control terminal of the gating circuit,
wherein a first pole of the thin film transistor comprises the first terminal of the gating circuit, and
wherein a second pole of the thin film transistor comprises the second terminal of the gating circuit.

20. The display apparatus according to claim 17,
wherein the voltage output circuit is configured to alternately provide the validating signal and the invalidating signal at a frequency between 50 Hz to 70 Hz.
